(19) United States
(12) Patent Application Publication
(10) Pub. No.: US 2004/0124079 A1
(43) Pub. Date: Jul. 1, 2004

(54) Process for the production of a gas diffusion electrode

(75) Inventors: Fritz Gestermann, Leverkusen (DE); Martin Sturmann, Leverkusen (DE); Gerd Speer, Burscheid (DE); Michael Granz, Remscheid (DE); Peter Kohl, Neuberg (DE)

Correspondence Address: CONNOLLY BOVE LODGE & HUTZ LLP, SUITE 800, 1990 M STREET NW, WASHINGTON, DC, 20036-3425, US

(73) Assignee: BAYER AG

(21) Appl. No.: 10/663,835

(22) Filed: Sep. 17, 2003

(30) Foreign Application Priority Data
Sep. 27, 2002 (DE) 10245582.1
Jan. 17, 2003 (DE) 10301521.3

(51) Int. Cl. C25B 11/08; B05D 5/12; B05D 1/02; B05D 3/02

(52) U.S. Cl. 204/290.14; 427/421; 427/58; 427/372.2

(57) ABSTRACT

The present invention discloses a process for the production of a gas diffusion electrode, in particular for the electrolysis of an aqueous solution of hydrogen chloride, in a first step a) a dispersion of a catalyst containing a noble metal and of a proton-conducting ionomer in an organic solvent being sprayed onto an electrically conductive support optionally provided with a coating material containing an acetylene black/polytetrafluoroethylene mixture and, in a second step b), the organic solvent being removed.

### CROSS REFERENCE TO RELATED APPLICATIONS

This application claims priority to German Patent Application No. 102 45 582.1, filed Sep. 27, 2002 and German Patent Application No. 103 01 521.3, filed Jan. 17, 2003, the contents of which are incorporated herein by reference in their entireties.

### BACKGROUND OF THE INVENTION

1. Field of the Invention

The present invention relates generally to a process for the production of a gas diffusion electrode, and in particular to electrodes suitable for the electrolysis of an aqueous solution of hydrogen chloride.

2. Description of Related Art

A gas diffusion electrode for the electrolysis of aqueous solutions of hydrogen chloride (hydrochloric acid) generally has, as a rule: an electrically conductive support, e.g. a carbon or metal fabric, that is provided with a gas diffusion layer including, for example, an acetylene black/polytetrafluoroethylene mixture. A catalyst layer, i.e. of a catalyst/polytetrafluoroethylene mixture, is applied to the support provided with the gas diffusion layer. The catalyst is usually sorbed on carbon black (e.g. Vulcan® XC72). If the gas diffusion electrode is operated in direct contact with the ion exchange membrane, it is frequently additionally provided with a layer of a proton-conducting ionomer, e.g. Nafion®, in order to achieve better binding to the ion exchange membrane.

For the application of the gas diffusion layer and of the catalyst layer to a support, methods are generally known in which thickened liquids or pasty materials are applied by hand, for example, using a trowel, or mechanically, for example by the Teflon structure, and hence the pore structure of the layers. Only after sintering can a Nafion® layer be applied.

A disadvantage of known processes is their relatively high complexity, in that the layers have to be applied individually and with high uniformity, and relatively large amounts of catalyst are consumed. Moreover, the sintering is time-consuming since it takes several hours and furthermore has a disadvantage that microcracks form on the surface of the catalyst layer.

Furthermore, relatively pronounced corrosion is observable in the case of all catalysts containing a noble metal during a hydrochloric acid (HCl) electrolysis operation. This corrosion is caused by the chlorine which is formed during the operation of the electrolysis and which diffuses through the ion exchange membrane out of the anode half-cell into the cathode half-cell. The gas diffusion electrodes produced with the aid of processes according to the prior art exhibit comparatively high corrosion, and it is for this reason that the gas diffusion electrodes have to be replaced comparatively frequently. Consequently, the material cost and the cost for dismantling and installation of the gas diffusion electrodes are undesirably high.

### SUMMARY OF THE INVENTION

It was an object of the present invention to provide a process for the production of a gas diffusion electrode, which process does not have the said disadvantages. The process should be as simple as possible, i.e. should take place in as few operations as possible, and the amount of catalyst used should be as small as possible. The electrochemical activity of the gas diffusion electrodes during operation of the electrolysis cell should be at least as good as gas diffusion electrodes produced by known processes, i.e. the operating voltage should be as low as possible and the long-term stability as high as possible.

These and other objects can be achieved according to the invention, for example, by providing a process for the production of a gas diffusion electrode, in particular for the electrolysis of an aqueous solution of hydrogen chloride, characterized by

a) the spraying of a dispersion of a catalyst containing a noble metal and of a proton-conducting ionomer in an organic solvent onto an electrically conductive support optionally provided with a coating material containing an acetylene black/polytetrafluoroethylene mixture and

b) subsequent removal of the organic solvent.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### DETAILED DESCRIPTION OF A PREFERRED EMBODIMENT

An advantage of the process according to the invention is that spraying on a dispersion of the catalyst is simpler as compared with processes known from the prior art. It is generally not necessary to sinter the sprayed-on dispersion. Moreover, the amount of catalyst used when a dispersion of the catalytically active component is sprayed on can often be reduced by up to a factor of 4.

The catalyst containing a noble metal is preferably a compound of the formula MeIₓMeII₍₆₋ₓ₎E₈, MeI representing molybdenum, MeII representing ruthenium, platinum, rhenium, rhodium or palladium and E representing sulphur, selenium or chlorine. x is preferably from 0 to 6 and may be integral or nonintegral. The catalyst particularly preferably comprises a Chevrel phase, i.e. ternary molybdenum chalcogenides in some embodiments.

Furthermore, the catalyst can advantageously comprise a platinum-ruthenium alloy. Moreover, further binary, ternary or quaternary platinum alloys with metals of subgroups VI and VIII may be used if desired for any reason.

The catalyst containing a noble metal can be used as such, i.e. without additional substances. Preferably, however, the catalyst can be applied to an electrically conductive, chemically inert support material having a high specific surface area, preferably carbon black. The catalyst is preferably applied to the support material by sorption according to know methods. The sorbed catalyst is also referred to below as “catalyst material”. The application of the catalyst to, for example, carbon black can also be effected by precipitation, for example.

The electrically conductive support preferably comprises a woven fabric, braid, net and/or a nonwoven material comprising carbon, metal and/or sintered metal. The metal or sintered metal is advantageously resistant to hydrochloric acid in cases where the electrode will be used for electrolysis thereof. The support may include, for example, titanium, hafnium, zirconium, niobium, tantalum and/or a Hastelloy alloy.

The electrically conductive support can optionally be provided with a coating material which comprises an acetylene black/polytetrafluoroethylene mixture. This coating material can be applied to the electrically conductive support, for example, using a trowel, and then sintered at temperatures, for example of about 340° C. This coating material generally serves as gas diffusion layer. In contrast to the catalyst layer, the gas diffusion layer is generally substantially more hydrophobic and is capable of controlling the mass transfer: first, gas is preferably conveyed via nonwettable pores to the catalyst layer, and second water of reaction is preferably transported via wettable pores from the catalyst layer into the back space. The gas diffusion layer can be applied for example, over the whole surface of the electrically conductive support. It can also be completely or partly embedded in an open-pore structure of the support, a woven fabric, braid, net or the like.

The electrically conductive support provided with a gas diffusion layer is also referred to below as “substrate”. Such an electrically conductive support comprising a nonwoven carbon material provided with a gas diffusion layer comprising an acetylene black/polytetrafluoroethylene mixture is commercially available, for example, from SGL Carbon Group, type GLD 10 AC.

In a first step a) of a suitable process according to the invention, a dispersion of the catalyst and of a proton-conducting ionomer in an organic solvent is sprayed onto the electrically conductive support or onto the substrate, i.e. the electrically conductive support provided with the coating material. Thereafter, in a second step b), the organic solvent is removed. This is effected, for example, by drying, preferably at a temperature of from 0 to 115° C., particularly preferably at a temperature of from 10 to 20° C.

The spraying of the dispersion according to step a) is preferably effected over the whole area. The application of the dispersion should advantageously be effected as uniformly as possible with respect to the surface loading. Furthermore, a mechanical bond between the dispersion and the gas diffusion layer is advantageously ensured. The layer thickness is preferably not more than about 10 μm, particularly preferably from 5 to 8 μm.

A suitable proton-conducting ionomer is, for example, Nafion®, a polytetrafluoroethylene modified with sulphonic acid groups and which is commercially available, for example, as a dispersion in alcohol, preferably isopropanol.

Organic solvents having a boiling point of, preferably, from 50 to 115° C. are suitable for dispersing the catalyst and the proton-conducting ionomer. Isopropanol is preferably used.

The preparation of the dispersion can be effected for example, by stirring the catalyst in the organic solvent. It is desirable that the catalyst be wetted as completely as possible. A stirrer having a high shear force is therefore preferably used as the dispersing apparatus. The proton-conducting ionomer, in particular Nafion®, can be added together with the catalyst or thereafter or in any manner desired. The ratio of the mass of the catalyst to the mass of the proton-conducting ionomer in the dispersion is preferably from 1:1 to 15:1, particularly preferably from 3:1 to 6:1. The volume of the organic solvent in relation to the mass of the catalyst may preferably be such that the solvent is just sufficient to obtain a sprayable dispersion. The organic solvent can, however, also be used in excess, in which case the dispersion can be initially left to stand for a period of time after stirring, in order for the excess to settle out. The clear supernatant can then be decanted and discarded.

After spraying on of the dispersion and subsequent drying, according to a preferred embodiment of the process, in a further step c), a dispersion comprising a proton-conducting ionomer in an organic solvent is sprayed on. Thereafter, the organic solvent is removed in a step d). This is preferably effected by drying at a temperature of from 0 to 115° C., particularly preferably from 10 to 20° C.

If the proton-conducting ionomer used is the commercially available Nafion® from DuPont, the organic solvent for the dispersion used in step c) is preferably isopropanol. Alternatively, other organic solvents may also be used. The spraying on is preferably effected over the whole surface and uniformly.

In a preferred embodiment of a process according to the invention, the dispersion according to a) and/or the dispersion of the proton-conducting ionomer according to c) is sprayed on several times, in particular from 2 to 5 times, the organic solvent being removed after each spraying. The number of spray operations is dependent on the desired loading of the support and the spraying characteristics of the spraying apparatus. Any number of spraying and drying steps can be conducted. It is preferred that only the first spray dispersion contain a catalyst, although it is possible for one or more of the subsequent spray dispersions to also contain a catalyst.

Drying is effected in each case for example, preferably at temperatures of from 0 to 115° C. During operation of the electrolysis cell, the gas diffusion electrodes showed no differences in the cell voltage as a function of the temperature and of the duration of the drying process. However, drying can often be decisive for increasing the stability of the catalyst layer and the service life of the gas diffusion electrodes. Such a simple drying process is advantageous compared with sintering because drying is less time-consuming than sintering and the materials used are subjected to less stress. In particular, no microcracks are formed in the surface of the catalyst or Nafion® layer during drying.

Gas diffusion electrodes which are loaded with from 0.5 g/m² to 10 g/m² of the noble metal of the catalyst are preferably produced. If the catalyst is applied to a support material, in particular carbon black, the optimum catalyst loading is generally dependent on the noble metal concentration on the carbon black. The optimum loading for a catalyst containing 30% by weight of noble metal is from 1.5 to 4 g/m² of noble metal.

A further advantage of the gas diffusion electrodes produced by a process according to the invention is their lower corrosion. In the case of the gas diffusion electrodes produced by the process according to the invention, the corrosion can be a factor of from 3 to 5 lower in comparison with the gas diffusion electrodes produced according to prior art processes. This applies in particular to the startup phases of the electrolysis, during which free chlorine, which diffuses out of the anode half-cell through the ion exchange membrane into the cathode half-cell, can be detected in the region of the gas diffusion electrodes.

### EXAMPLES

### Example 1

The Chevrel phase of Mo₄Ru₂Se₈ was prepared according to the process described in Int. J. Hydrogen Energy, Vol. 23, No. 11, pages 1031-1035 (1998) as catalyst, in the presence of Vulcan® XC72 as electrically conductive support material. The X-ray diffraction pattern of the catalyst material on Vulcan® XC72 showed signals of unconverted elemental selenium. The catalyst formed was X-ray amorphous. It was shown by X-ray spectroscopy that the ratio of molybdenum to ruthenium to selenium corresponded to the amounts used, i.e. that no volatilization of the carbonyls used has taken place.

The catalyst sorbed onto Vulcan® XC72 was separated from the xylene used as a solvent for the preparation. No further treatment of the catalyst was carried out. 2 g of the catalyst sorbed onto Vulcan® XC72 were dispersed in 100 ml of isopropanol, and 0.5 g of Nafion®, contained in a commercial solution from DuPont, was added. The dispersion was vigorously stirred and left to stand overnight. The stirrer used was an Ultraturrax C25 from IKA Labortechnik (Germany). The clear supernatant was then decanted and discarded. The remaining dispersion was sprayed onto a substrate (step a)). The substrate consisted of a carbon fabric which had been provided on one side with a gas diffusion layer comprising 50% by weight of acetylene black and 50% by weight of Teflon with a loading of 40 g/m². By spraying on in three passes, the substrate was loaded with, altogether, 12 g/m² of catalyst material, corresponding to 1.0 g/m² of Ru. After each spray operation, drying was effected for 30 minutes at a temperature of 50° C. (step b)). Nafion® was then sprayed on in three passes with loading of, altogether, 7.4 g/m² (step c)). After each spray operation, drying was effected for 30 minutes at 50° C. (step d)). Sintering was then effected for one hour at 115° C.

The gas diffusion electrode produced in this manner was used in an electrolysis cell for the electrolysis of a 14% strength by volume technical-grade hydrochloric acid at 60° C. The anode gap, i.e. the distance between the anode and the ion exchange membrane, was 3 mm. The ion exchange membrane used was Nafion® 324. Pure oxygen was used for operating the gas diffusion electrode.

The gas diffusion electrode had an operating voltage of 1.38 volt at a current density of 5 kA/m², an operating voltage of 1.02 volt at 2 kA/m² and a voltage of 1.71 volt at 8 kA/m².

Evolution of hydrogen which was observed in some cases during the operation of other electrode types could not be found with this electrode within the accuracy of detection (<40 ppm). Also surprising was that the gas diffusion electrode showed no sensitivity to the impurities of a technical-grade hydrochloric acid, as is observable, for example, in the case of gas diffusion electrodes with platinum as catalyst.

### Example 2

2 g of a commercially available catalyst sorbed on Vulcan® XC72 and containing 20% by weight of a platinum-ruthenium alloy with an atomic ratio of 50:50 were dispersed analogously to example 1 in isopropanol. The dispersion was sprayed, as described in example 1, in three layers onto the substrate, in each case the organic solvent first being removed, as described in example 1, after a layer had been sprayed on. A substrate analogous to example 1 was used. The loading of the substrate with the catalyst applied to Vulcan® XC72 was 13.2 g/m². Nafion® was sprayed in two layers onto this coating comprising the catalyst, the loading being, altogether, 8.3 g/m². After the first Nafion® layer had been sprayed on, the organic solvent was first removed analogously to example 1 by drying before the second layer was sprayed on. The gas diffusion electrode having an area of 10×10 cm² was finally sintered for 1 h at 115° C.

Under the conditions stated in example 1, the gas diffusion electrode had an operating voltage of 1.36 V at a current density of 5 kA/m², an operating voltage of 1.0 V at a current density of 2 kA/m² and a voltage of 1.66 V at a current density of 8 kA/m² during operation of the electrolysis cell. Here too, no evolution of hydrogen was observed. Furthermore, the gas diffusion electrode surprisingly proved to be inert to impurities of the technical-grade hydrochloric acid over an operating time of 22 days. This means that the operating voltage was constant over the total operating time.

As used herein and in the following claims, articles such as “the”, “a” and “an” can connote the singular or plural.

All documents referred to herein are specifically incorporated herein by reference in their entireties.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

What is claimed is:

1. A process for the production of a gas diffusion electrode, suitable for use in electrolysis of an aqueous solution of hydrogen chloride, comprising:
a) spraying a dispersion comprising a noble metal catalyst and a proton-conducting ionomer in an organic solvent onto an electrically conductive support, said support optionally being provided with a coating comprising an acetylene black/polytetrafluoroethylene mixture and
b) removing the organic solvent.

2. A process according to claim 1, wherein said catalyst comprises a compound of the formula MeIₓMeII₍₆₋ₓ₎E₈, wherein MeI is molybdenum, MeII is ruthenium, platinum, rhenium, rhodium or palladium, E is sulphur, selenium or chlorine and x is from 0 to 6.

3. A process according to claim 1, wherein said catalyst comprises a platinum-ruthenium alloy.

4. A process according to claims 1, further comprising
c) spraying a second dispersion comprising proton-conducting ionomer in an organic solvent and
d) removing said organic solvent.

5. A process according to claim 1, wherein as a result of said spraying of the dispersion according to a) and removing the solvent according to b), the electrically conductive support is loaded from 0.5 g/m² to 10 g/m², based on the noble metal of the catalyst.

6. A process according to claim 1, wherein said electrically conductive support has a high specific surface area.

7. A process according to claim 1, wherein said support comprises carbon black.

8. A process according to claim 6, wherein the ratio of the mass of the catalyst to the mass of the proton-conducting ionomer is from 1:1 to 15:1.

9. A process according to claim 8, wherein said ratio is 3:1 to 6:1.

10. A process according of claim 1, wherein the electrically conductive support comprises a woven fabric, braid, net and/or nonwoven materials comprising carbon, metal and/or sintered metal.

11. A process according to claim 1, wherein said dispersion and/or said second dispersion comprises a dispersion of Nafion® in alcohol.

12. A process according to claim 1, wherein the dispersion according to steps a) and b) is sprayed on at least two times, and/or the second dispersion according to step c) and d) is sprayed on at least two times.

13. A gas diffusion electrode obtained by a process according to claim 1.

14. A process for the production of a gas diffusion electrode, suitable for use in electrolysis of an aqueous solution of hydrogen chloride, comprising:
a) spraying a dispersion comprising a noble metal catalyst and a proton-conducting ionomer in an organic solvent to form a gas diffusion electrode, and
b) removing the organic solvent.

15. A gas diffusion electrode prepared according to a process of claim 14.

16. A process according to claim 14 wherein said spraying and removing are conducted at least two times each.

17. A process according to claim 14, wherein after removing said organic solvent, a second dispersion that is the same or different than said dispersion is sprayed onto said support.

18. An electrode prepared according to a process of claim 17.

19. A gas diffusion electrode that has been prepared by spraying and drying catalyst on a support and wherein sintering is not employed in the preparation thereof.

20. A gas diffusion electrode according to claim 19, wherein said electrode is loaded with from 0.5 to 10 g/m² of said catalyst.

21. A gas diffusion electrode according to claim 19, wherein said catalyst is a noble metal catalyst.
